(19) United States
(12) Patent Application Publication
(10) Pub. No.: US 2011/0079587 A1
(43) Pub. Date: Apr. 7, 2011

(54) WELDING HEAD FOR A MACHINE FOR THE FORMATION OF METAL MESH, RELATIVE WELDING METHOD AND MACHINE FOR THE FORMATION OF METAL MESH USING SAID WELDING HEAD

(75) Inventor: Ermanno TABOGA, Buia (IT)

(73) Assignee: BETA SYSTEMS SRL CON UNICO SOCIO, Reana Del Rojale (IT)

(21) Appl. No.: 12/935,188

(22) PCT Filed: Mar. 25, 2009
(86) PCT No.: PCT/EP2009/053503

§ 371 Date: Sep. 28, 2010

(30) Foreign Application Priority Data
Mar. 28, 2008 (IT) UD2008A000067

(51) Int. Cl. B23K 11/24

(52) U.S. Cl. 219/117.1; 219/119

(57) ABSTRACT

A welding head for the formation of a metal mesh includes longitudinal wires (12) and transverse wires (13), having at least a feed unit (16) able to feed step-wise a plurality of longitudinal wires (12), and a welding unit (17) by which the longitudinal wires (12) are welded to corresponding transverse wires (13). The welding unit (17) includes at least two electrodes (19,20) selectively movable between a first feed position and a second welding position. The welding head includes at least a movement member (22) to move the first electrode (19) between the first and the second position, first sensor members (25) associated with the movement member (22) and configured to detect the position of the first electrode (19) with respect to the two wires (12,13) and/or second sensor members (30,31) to detect the working pressure of the first electrode (19).

### CROSS-REFERENCE TO RELATED APPLICATIONS

This application is a section 371 of International Application No. PCT/EP2009/053503, filed Mar. 25, 2009, which was published on Oct. 1, 2009 under International Publication No. WO 2009/118334 A1 and the disclosure of which is incorporated herein by reference.

### BACKGROUND OF THE INVENTION

The present invention concerns a welding head used in a machine for the production of a metal mesh, the relative production method and the machine provided with the welding head. The present invention is applied preferentially, but not exclusively, to create electro-welded metal meshes used as reinforcement for structures of reinforced concrete. For this reason, in the following description, specific reference will be made to the present application, although the present invention can also be used for the formation of meshes of other types.

Different machines are known for the production of electro-welded metal meshes made up of a plurality of longitudinal metal wires, or round pieces, separated from each other. Corresponding transverse metal wires or round pieces are welded perpendicularly on the longitudinal wires, according to pre-defined interaxis.

These machines generally comprise a plurality of welding heads, at least one for every longitudinal wire, and a feed unit to feed the transverse wires.

Each welding head comprises at least a feed unit to feed the longitudinal wires and a welding unit, and is selectively movable parallel to the direction of the feed of the transverse wires, in order to regulate the positioning distance of the longitudinal wires.

In particular, the welding unit comprises two electrodes, able to be selectively moved closer to each other so as to be moved between a first feed position, in which at least one electrode is distanced from the two wires in order to allow the free positioning thereof, and a second welding position in which both the electrodes contact and grip the two wires in correspondence with one of their join segments. In the second position the two electrodes apply different tensions determining the welding of the two wires.

The functioning of the machines provides that a transverse wire, in some cases several transverse wires simultaneously, is fed and disposed in an attachment position in which it is joined to the longitudinal wires by means of the welding unit.

Subsequently the longitudinal wires are simultaneously fed forward by a pitch equivalent to the interaxis between the transverse wires, so that a new transverse wire can be fed and disposed in the attachment position.

One of the main limits of such machines is the speed of movement of the electrodes between the first and the second position.

This speed is normally kept substantially constant and suitably high, both to limit costs and bulk, and also to reduce to a minimum the downtimes of the machine due to the welding steps.

In this way, the action of the electrodes on the metal wires also determines a beating effect on the wires.

This beating effect causes, on the one hand, a rapid wear of the electrodes which are normally made of ductile material, such as copper or similar, and, on the other hand, a high mechanical stress on the frame of the machine, considering that the machine can comprise tens of different welding heads acting simultaneously.

Another limit of known machines is the difficulty of guaranteeing a correct and uniform positioning of the longitudinal wires, both between each other and also with respect to the transverse wires.

To overcome this limit, it is known to provide complex and voluminous alignment members to align the wires and to coordinate the welding heads.

Furthermore, there is a growing need to create electro-welded metal meshes in which the interaxes between the longitudinal wires and the transverse wires are reduced to a minimum.

One purpose of the present invention is to achieve a welding head, and to perfect a welding method, for a machine for the formation of electro-welded metal meshes, which solves the disadvantages of the wear of the electrodes, the mechanical stress of the frame, the alignment of the wires and the bulk, without compromising the normal productivity and the quality of work of known machines.

The applicant of the present application has devised, tested and embodied the present invention to overcome the shortcomings of the state of the art and to obtain these and other purposes and advantages.

### BRIEF SUMMARY OF THE INVENTION

The present invention is set forth and characterized in the independent claim(s), while the dependent claims describe other characteristics of the invention or variants to the main inventive idea.

In accordance with the above purpose, a welding head according to a preferred embodiment of the present invention is used in a machine for the formation of metal mesh, and comprises at least a first feed unit able to feed step-wise a plurality of longitudinal wires of the metal mesh, and a welding unit by means of which the longitudinal wires are attached by welding, with a pre-defined or pre-definable pitch, to corresponding transverse wires of the metal mesh.

The welding unit comprises two electrodes, selectively movable between a first feed position, in which at least a first electrode is distant from the two wires to be welded, and a second welding position in which both the electrodes contact and grip the two wires to be welded and apply different tensions determining the welding of the two wires.

According to a characteristic feature of a preferred embodiment of the present invention, the welding head comprises at least a movement member, for example of the fluid-dynamic type, operatively associated at least with the first electrode in order to move it between the first and the second position, first sensor means associated with the movement member and configured to detect the position of the first electrode with respect to the two wires, and/or second sensor means associated with the movement member and configured to detect the working pressure of the first electrode.

In this way, by commanding the movement member in a coordinated way according to the data detected by the first and/or by the second sensor means, it is possible to set a first speed, relatively high, of the electrode when it approaches the wires, and subsequently, according to the position detected of the electrode and to the sizes of the wires, to set a second relatively slower approach speed, until it contacts the wires. The contact of the electrode with the wires is detected by the second sensor means which detects an increase in pressure, stopping the movement member when a pre-determined threshold is reached, and then applying the welding tension.

Therefore, in substantially the same operating time as known welding heads, the electrode is first moved closer at high speed and then slowed down until it contacts and rests on the wires, thus avoiding the disadvantage deriving from the beating of the electrodes against the wires.

With the present invention the wear on the electrodes, and therefore their frequency of maintenance, is considerably reduced; the mechanical stress on the frame of the machine is also reduced, thus allowing to provide simpler and less costly machines.

In a variant, the first and second sensor means are integrated in a single body in the movement member, so that the bulk relating to the welding head are reduced with respect to the state of the art.

According to a variant, the first sensor means comprise at least a linear transducer device of the electro-magnetic type, which comprises at least a mobile magnetic element together with the electrode and able to emit a relative magnetic field, and an electronic measuring element, fixed with respect to the electrode, and able to detect the intensity of the magnetic field emitted by the magnetic element in order to identify the position thereof, according to the value detected.

According to another variant, the second sensor means comprises at least a first pressure switch able to detect the pressure of the actuating or delivery fluid of the movement member, and a second pressure switch able to detect the pressure of the fluid returning from the movement member.

In this way, by measuring the difference in potential between the pressure of the fluid delivered and the pressure of the fluid returning, and by comparing it with a limit variation, it is possible to detect the possible stopping of the electrode.

According to another variant, the first sensor means and the second sensor means are configured and disposed in the movement member in such a way as to reduce to a minimum the bulk of the movement member, at least in width.

In this way it is possible to reduce to a minimum the distance between two welding heads of the same machine, and to reduce to a minimum the distance between two adjacent longitudinal wires of the same electro-welded mesh as well.

According to another variant, the welding head comprises a positioning unit, in which at least two positioning guides are provided, disposed substantially aligned and staggered with each other with respect to an axis of feed of the longitudinal wire.

The two positioning guides are disposed, respectively, one above and one below the longitudinal wire and have a “V” shaped guide seating open toward the axis of feed, in such a way that the reciprocal action of the two guides determines a substantial centering of the longitudinal wire toward the axis of feed.

Advantageously, an elastic member is associated with at least one positioning guide, which allows to auto-center the relative guide seating with respect to the longitudinal wire being fed, and to push it toward the axis of feed.

This variant allows to center the relative longitudinal wire with respect to the axis of feed, in a simple and effective way and with the minimum possible bulk in width, thus facilitating welding operations.

According to another variant, the first feed unit comprises at least a pair of feed rollers able to cooperate from opposite sides on the longitudinal wire in order to feed it toward the welding unit, and a header member able to selectively cooperate, at least in an initial step of the cycle to form the mesh, with a leading end of the longitudinal wire. In this way, all the longitudinal wires provided on each welding head are headed simultaneously, avoiding a staggered positioning between the various longitudinal wires, with respect to the transverse wires.

According to a further variant, at least one roller of the pair of feed rollers is selectively mobile toward the longitudinal wire to be fed, in such a way as to allow to regulate the distance between the two rollers, depending on the diameter of the wire. Advantageously, the movement of this mobile roller is carried out using a cylinder with an oval chamber, in order to reduce to a minimum the lateral bulk of the feed unit.

According to another variant, in which the machine for the formation of metal mesh comprises a frame on which a plurality of welding heads are mounted, each welding head also comprises sliding means, translation means and stopping means, which allow to translate the welding head laterally and independently with respect to the frame of the machine, to then to clamp it in a desired position in relation to the pitch of the longitudinal wires.

In this way, it is possible to vary as desired, and in a guided and controlled manner, the reciprocal distance between the adjacent welding heads, and therefore of the longitudinal wires of the metal mesh.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective view of a machine to make a metal mesh provided with two welding heads according to a preferred embodiment of the present invention;

FIG. 2 is a perspective sectioned view of the machine shown in FIG. 1;

FIG. 3 is a perspective view of a welding head according to a preferred embodiment of the present invention;

FIG. 4 shows an enlarged sectioned view of the welding head shown in FIGS. 3; and

FIG. 5 shows an enlarged sectioned view of the welding head shown in FIG. 3.

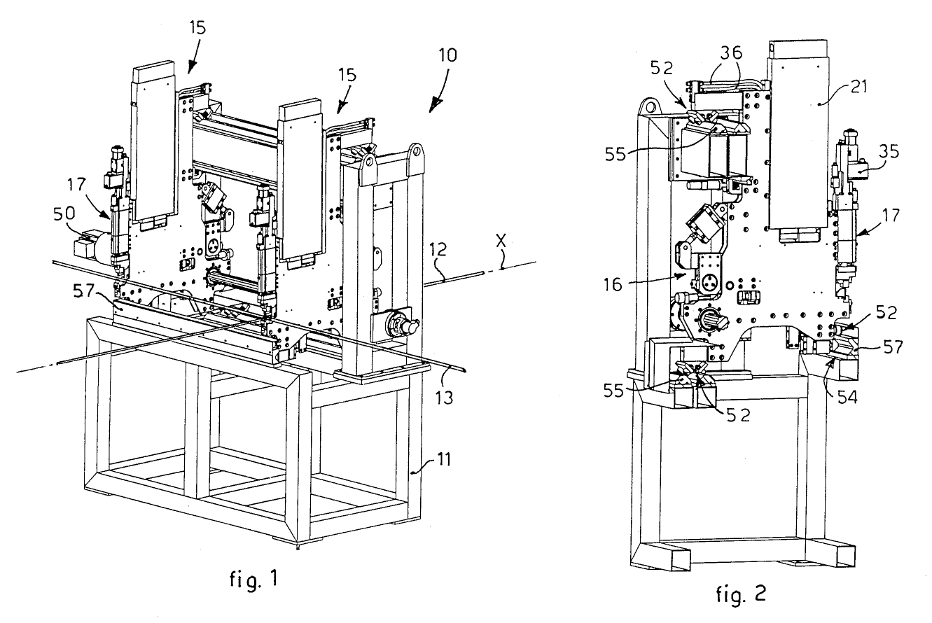

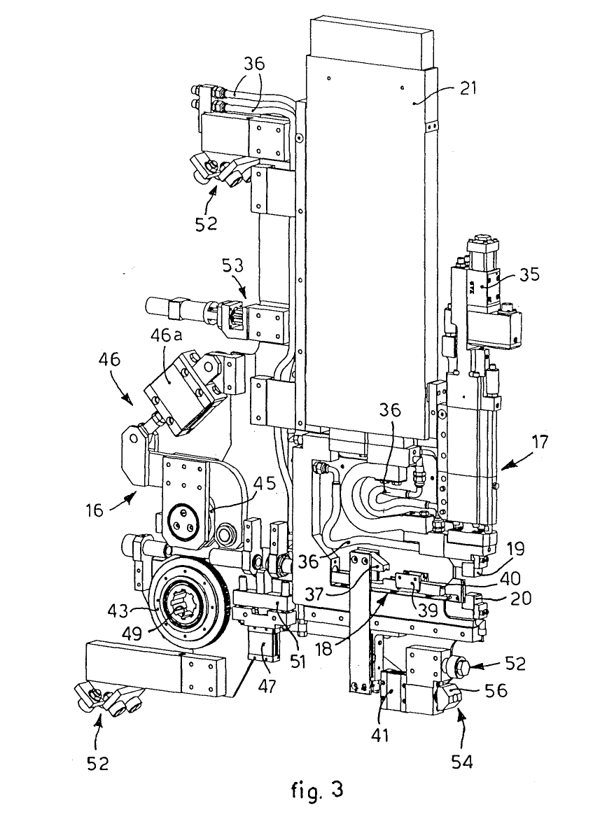

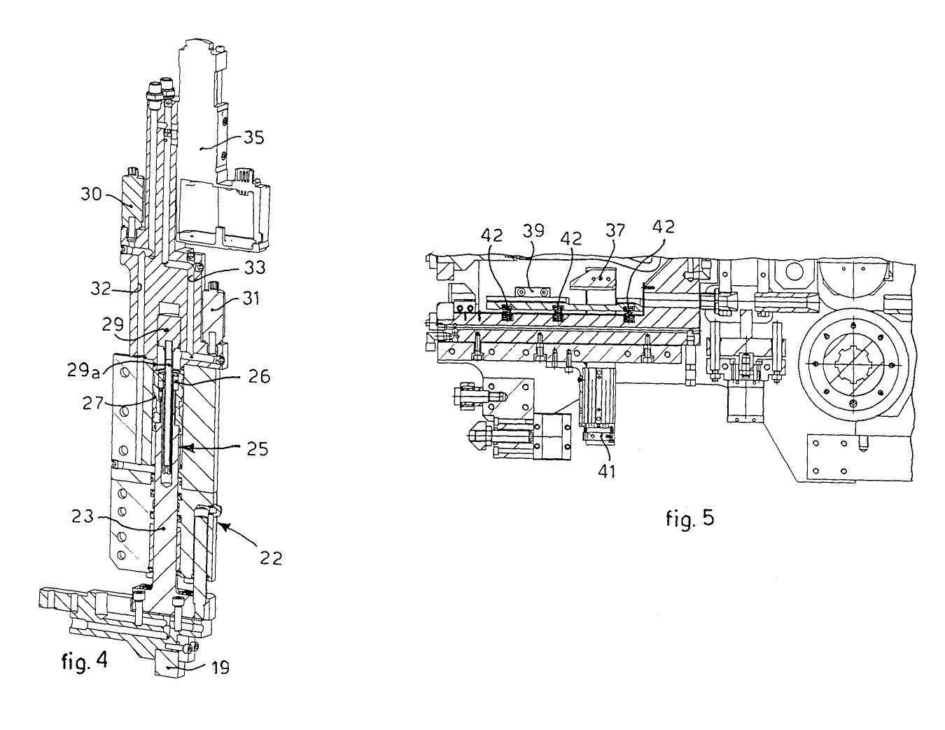

### DETAILED DESCRIPTION OF THE INVENTION

Certain terminology is used in the following description for convenience only and is not limiting. The words “lower,” “upper,” “front” and “rear” designate directions in the drawings to which reference is made. Unless specifically set forth herein, the terms “a,” “an” and “the” are not limited to one element, but instead should be read as meaning “at least one.” The terminology includes the words noted above, derivatives thereof and words of similar import.

Referring to the drawings in detail, wherein like numerals indicate like elements throughout the several views, the number 10 denotes in its entirety a machine for the formation of electro-welded mesh according to a preferred embodiment of the present invention.

In this case, the electro-welded meshes formed with the machine 10 comprise a plurality of longitudinal metal wires 12 distanced from each other and welded to corresponding transverse metal wires 13, also distanced by a predefined interaxis.

The machine 10 substantially comprises a frame 11, a plurality of welding heads 15, in the simplified case shown here as an example only, two, mounted sliding on the frame 11, and a transverse feed unit (not shown) able to feed the transverse wires 13, in order to dispose them in cooperation with the welding heads 15.

Each welding head 15 comprises at least a feed unit 16 to feed the longitudinal wires 12, a positioning unit 18, able to maintain the longitudinal wires 12 substantially aligned with an axis of feed X, and a welding unit 17. Each welding head 15 is selectively movable with respect to the frame 11, in an independent way, in a direction substantially parallel to the direction of feed of the transverse wires 13, so as to regulate the positioning distance of the longitudinal wires 12.

The welding unit 17 is disposed in correspondence with the join zone between the longitudinal wires 12 and the relative transverse wire 13. The welding unit 17 comprises a first upper electrode 19 and a second lower electrode 20 which, fed by a tension generator unit 21, apply different tensions on the wires 12, 13, determining the welding thereof

In particular, the upper electrode 19 is selectively movable by means of a movement member 22, while the second electrode 20 is fixed and on this the transverse wire 13 and the longitudinal wire 12 are able to be positioned in their join position. The movement member 22 is actuated fluid-dynamically and comprises at least a shaft 23, disposed substantially vertically, and to which the first electrode 19 is fixed.

In this way, the first electrode 19 is selectively movable between a first feed position, in which it is raised and distanced from the second electrode 20 and allows the free feed of both the transverse wire 13 and the longitudinal wire 12, and a second welding position, in which it is near to the second electrode 20 and with this contacts the two wires 12, 13. In this condition, the tension generator unit 21 feeds to the electrodes 19, 20 the tensions that determine the welding of the two wires 12, 13.

The movement member 22 also comprises, and id integrated with it, a transducer device 25 to measure the position of the first electrode 19, and a pair of pressure switches, respectively first 30 and second 31, to measure the working pressure of the first electrode 19. The transducer device 25 is of the linear type with electro-magnetic function and comprises at least a magnet 26 of an annular shape fixed axially to the shaft 23 by means of a jacket 27, and an electronic measuring element 29 mounted fixed inside the movement member 22, and having at least an oblong part 29a inserted axially through the magnet 26. Both the magnet 26 and the electronic measuring element 29 have a reduced lateral bulk compared with the maximum lateral bulk of the movement member. In this way, the magnet 26 emits a determinate magnetic field and moves with the shaft 23 when the first electrode 19 is moved between one and the other of its positions, while the electronic measuring element 29 detects at intervals the intensity of the magnetic field emitted by the magnet 26.

Depending on the intensity of the magnetic field detected, the electronic measuring element 29 recognizes the distance between it and the magnet 26, and therefore obtains the position of the first electrode 19 with respect to, for example, the second electrode 20.

The first pressure switch 30 and the second pressure switch 31 are mounted outside the movement member 22, respectively on a front edge and a rear edge, and both have a smaller lateral bulk than the maximum lateral bulk of the movement member 22. The first pressure switch 30 is hydraulically connected to a delivery pipe 32 through which a fluid to move the shaft 23 flows. In particular, the fluid flows under pressure through the delivery pipe 32 when the first electrode 19 is commanded to be lowered to its second position. The second pressure switch 31 is hydraulically connected to a return pipe 33 through which the fluid to move the shaft 23 flows. In particular, the fluid flows under pressure through the return pipe 33 when the first electrode 19 is commanded to be raised to its first position.

The feed of the movement fluid from and toward the shaft 23 is managed by an electro valve 35, electronically connected both to the transducer device 25 and also to the two pressure switches 30 and 31. In this way, also depending on the diameters of the two wires 12 and 13, when the first electrode 19 is moved from the first to the second position, the movement occurs for at least a first segment with a first high speed.

The first high speed is maintained until the transducer device 25 detects that the position of the first electrode 19 is near to the two wires 12, 13. At this point the electro valve 35 determines a reduction in the flow rate of the fluid through the delivery pipe 32, causing a reduction in the speed of movement of the first electrode 19. The greater the reduction in the flow rate, the greater the reduction in speed.

At the moment when the first electrode 19 rests on the two wires 12, 13, the two pressure switches 30, 31 detect different pressures in the respective delivery pipe 32 and return pipe 33. This difference in pressure potential, at the moment it exceeds a pre-defined limit, determines the stoppage, by the electro valve 35, of the feed of the movement fluid, and the activation of the tension generator unit 21, to carry out the welding.

In proximity to the different electric, mechanic and fluid-dynamic members of the welding unit 17 as described heretofore, a plurality of cooling pipes 36 are provided, able to limit the overheating of the parts.

The positioning unit 18 is disposed upstream of the welding unit 17 with respect to the direction of feed of the longitudinal wires 12. The positioning unit 18 comprises a first positioning guide 37 and a second positioning guide 39 disposed substantially aligned and staggered with each other with respect to the axis of feed X of the longitudinal wire 12. In particular, the first positioning guide 37 is disposed above the longitudinal wire 12, while the second positioning guide 39 is disposed below the longitudinal wire 12.

Each of the positioning guides 37, 39 comprises a guide seating 40 conformed as a “V” and open toward the axis of feed X, so as to cooperate from opposite sides with the longitudinal wire 12 and to maintain it substantially centered toward the axis of feed X. The first positioning guide 37 is selectively movable toward the second positioning guide 39, by means of a linear actuator 41, so that it can be selectively regulated depending on the diameter of the longitudinal wire 12. The second positioning guide 39 is associated with a plurality of elastic springs 42 which carry out a normal thrust toward the first positioning guide 37, allowing to auto-center the relative guide seating 40 with respect to the longitudinal wire 12 fed, and to maintain the latter toward the axis of feed X.

The two positioning guides 37, 39, the linear actuator 41 and the elastic springs 42 all have a smaller lateral bulk than the maximum lateral bulk of the movement member 22 of the welding unit 17.

The feed unit 16 is disposed upstream of the positioning unit 18, with respect to the direction of feed of the longitudinal wires 12. The feed unit 16 substantially comprises: a pair of feed rollers 43, 45, a compression mechanism 46 and a header device 47. In particular, a first roller 43 of the pair is motorized by means of a grooved profile 49, common for all the feed units 16 of the welding heads 15, while a second roller 45 of the pair is mobile with respect to the first roller 43 and is mechanically connected to the compression mechanism 46, provided with a cylinder having an oval chamber 46a. The grooved profile 49 is selectively made to rotate by means of a motor reducer 50.

The header device 47 substantially comprises a block 51 shaped in such a way as to substantially define an upside down T profile, able to be moved by actuation means of a known type from a first position in which it allows the passage of the relative longitudinal wire 12, to a second position in which it clamps the leading end of the relative longitudinal wire 12 in order to head it. In this way all the longitudinal wires 12 provided on each welding head 15 are simultaneously headed.

Each welding head 15 is also provided with sliding members 52, translation members 53 and a stopping element 54, which allow to translate laterally each welding head in an independent manner and then to clamp it in the desired position. The sliding members 52 are associated respectively with the upper and lower parts of the welding head 15, and are able to cooperate in a known manner with corresponding sliding guides 53 associated with the frame 11, in such a way as to always maintain each welding head in position.

The translation members 53 in this case substantially comprise a rack type mechanism and allow the lateral sliding of each welding head 15 in order to be able to position each welding head 15 in the desired position.

The stopping element 54 is disposed substantially in correspondence with and under the positioning unit 18. The stopping element 54 comprises a block 56, having a substantially trapezoidal shape, able to be moved substantially in the direction of the axis X, in order to cooperate with a corresponding clamping bar 57, in such a way as to clamp the welding head 15 in the desired position. It is clear, however, that modifications and/or additions of parts may be made to the machine 10 as described heretofore, without departing from the field and scope of the present invention.

It is also clear that, although the present invention has been described with reference to specific examples, a person of skill in the art shall certainly be able to achieve many other equivalent forms of machine 10, having the characteristics as set forth in the claims and hence all coming within the field of protection defined thereby.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-18. (canceled)

19. A welding head for the formation of a metal mesh comprising longitudinal wires and transverse wires, the head comprising at least a feed unit for feeding step-wise a plurality of said longitudinal wires, and a welding unit by which said longitudinal wires are welded to corresponding transverse wires, said welding unit comprising at least two electrodes selectively movable between a first feed position, in which at least a first electrode is distant from said transverse and longitudinal wires, and a second welding position, in which both the electrodes contact and grip said wires and apply different tensions in order to weld said wires to each other, wherein the welding head comprises at least a movement member operatively associated at least with the first electrode in order to move the first electrode between said first and said second positions, wherein the welding head further comprises a first position sensor associated with said movement member and configured to detect the position of the first electrode with respect to the two wires and to cause a reduction of the speed of movement of said first electrode when said first electrode is in a position near said wires, and a second and a third pressure sensors associated with the movement member, and configured to detect the working pressure of the first electrode when the first electrode contacts said wires and to cause the stoppage of the movement member when a pre-determined threshold of pressure is reached.

20. The welding head according to claim 19, wherein said first sensor means comprises at least linear transduction means of the electro-magnetic type having at least a magnetic element mobile with the first electrode, able to emit a relative magnetic field.

21. The welding head according to claim 20, wherein said transduction means comprises electronic measuring means fixed with respect to said first electrode able to detect the intensity of the magnetic field of said magnetic element.

22. The welding head according to claim 19, wherein said second pressure sensor comprises at least a first pressure switch able to detect the pressure in delivery of a fluid that actuates the movement member and said third pressure sensor comprises at least a second pressure switch able to detect the pressure of said fluid returning from the movement member.

23. The welding head according to claim 19, wherein said first position sensor and said second and third pressure sensors are integrated in a single body with said movement member.

24. The welding head according to claim 19, wherein the welding heal comprises a positioning and centering unit of the longitudinal wire with respect to an axis. feed of the longitudinal wire.

25. The welding head according to claim 24, wherein said positioning unit comprises at least two positioning guides, substantially aligned and staggered with each other with respect to the axis of feed of the longitudinal wire.

26. The welding head according to claim 25, wherein, in use, said at least two positioning guides are disposed one above and one below the longitudinal wire.

27. The welding head according to claim 25, wherein said at least two positioning guides have a guide seating conformed as a “V”, open toward the axis of feed.

28. The welding head according to claim 25, further comprising elastic means associated with at least one of the said positioning guides, able to center the relative guide seating of the positioning guide with respect to the longitudinal wire fed.

29. The welding head according to claim 19, wherein said feed unit comprises at least a pair of feed rollers able to cooperate from opposite sides on the longitudinal wire in order to feed the wire toward the welding unit.

30. The welding head according to claim 19, wherein the welding head comprises header means able to cooperate selectively with a leading end of the relative longitudinal wire in order to head the wire.

31. The welding head according to claim 29, wherein at least a roller of said pair of feed rollers is selectively movable toward the longitudinal wire to be fed, in order to allow the distance of the two rollers to be regulated according to the diameter of the longitudinal wire.

32. The welding head according to claim 31, wherein the movement of the mobile roller is carried out using a cylinder with an oval chamber.

33. The welding head according to claim 19, wherein the welding head comprises sliding means and translation means, able to translate said welding head laterally and in an independent manner with respect to a support frame of said welding head.

34. The welding head according to claim 33, wherein the welding head comprises stopping means cooperating with said sliding means and said translation means in order to clamp said welding head in the desired position.

35. A method for the formation of a metal mesh consisting of longitudinal wires and transverse wires, by a welding head comprising at least a feed unit able to feed step-wise a plurality of said longitudinal wires, and a welding unit by which said longitudinal wires are fixed by welding to corresponding transverse wires, said welding unit comprising two electrodes selectively movable between a first feed position, in which at least a first electrode is distant from said transverse and longitudinal wires, and a second welding position, in which both the electrodes contact and grip said wires and apply different tensions in order to weld said wires to each other, wherein the method comprises at least a first step in which a movement member of the fluid-dynamic type, operatively associated at least with the first electrode, is moved between said first position to a second position near but not in contact with said wires, according to information detected by a first position sensor associated with said movement member and configured to detect the position of the first electrode with respect to the two wires, a second step in which, after having reached said position near to the wires, a reduction of speed of the movement member is determined, and a third step in which the first electrode is brought in contact with said wires with a pressure detected by second pressure sensors associated with the movement member and configured to detect the working pressure of the first electrode until a pre-determined threshold is reached.

36. A machine for the formation of a metal mesh comprising a welding head as in claim 19.
